(19) United States
(12) Patent Application Publication
(10) Pub. No.: US 2010/0263244 A1
(43) Pub. Date: Oct. 21, 2010

(54) Labels and taggants with programmable multi color coded timing

(76) Inventors: Nelson Tabirian, Winter Park, FL (US); Sos Agaian, San Antonio, TX (US)

Correspondence Address: Nelson Tabirian, 760 Williams Dr., Winter Park, FL, 32789, US

(21) Appl. No.: 12/425,338

(22) Filed: Apr. 16, 2009

(51) Int. Cl. G09F 3/00; B41M 5/26

(52) U.S. Cl. 40/299.01; 503/201; 503/200

(57) ABSTRACT

The objective of the present invention is providing autonomous timing labels for indicating the aging and expiration of a time period of products through gradual changing of their color. The color change can be coded to run, for example, from blue for newly produced products to red with product aging thus allowing easy monitoring, quick identification, and visual warning when the elapsed time approaches and reaches the recommended or safe use time. Said labels comprise thin films of photonic bandgap materials such as cholesteric liquid crystals containing photoisomerizable molecules that are transformed into the state of isomers possessing with finite lifetime with the aid of exposure of the material to UV light. The change of the reflection wavelength of the photonic bandgap material takes place according to changing concentration of said isomers as a result of spontaneous relaxation to their equilibrium state. Said labels can be reused by UV light exposure. The invention has wide applications for time coding of information carriers such as badges, telephone, credit, and gift cards, electronic keys, product labels, shipping tags, storage tags, parking stickers or oil-change stickers for cars, and other carriers of information that are changing as a result of use or storage, and compliance indicators for medical, health, security, and other industries.

### CROSS REFERENCES

[1] http://money.aol.com/bw/general/canvas3/_a/the-truth-about-food-expiration-dates/20061003132209990001.

[2] “A Guide to Shelf Life”, BusinessWeek.com.

[3] U. A. Hrozhyk, S. V. Serak, N. V. Tabiryan, T. J. Bunning, Optical tuning of the reflection of cholesterics doped with azobenzene liquid crystals, Advanced Functional Materials, 17 (11), 1735-1742, 2007.

[4] U. A. Hrozhyk, S. V. Serak, N. V. Tabiryan, T. J. Bunning, “Photoinduced isotropic state of cholesteric liquid crystals: novel dynamic photonic materials,” Adv. Mater., 19, 3244-3247 (2007).

[5] C. J. Barrett, J. Mamia, K. G. Yager, T. Ikeda, Photo-mechanical effects in azobenzene-containing soft materials, Soft Matter 3, 1249-1261, 2007.

### U.S. PATENT DOCUMENTS

| | | |
|---|---|---|
| 4,292,916 | October 1981 | Bradley et al. |
| 5,446,705 | August 1995 | Haas et al. |
| 5,785,354 | July 1998 | Haas |
| 6,452,873 | September 2002 | Holt et al. |
| 6,801,477 | October 2004 | Braunbergere |
| 6,990,688 | January 2006 | Aperfine et al. |
| 7,263,037 | August 2007 | Haas |
| 7,294,379 | November 2007 | Ko et al. |
| 6,397,503 | June 2002 | Cain et al. |
| 6,817,192 | November 2004 | Ector et al. |
| 5,802,015 | September 1998 | Rothschild et al. |
| 5,974,003 | October 1999 | Pedicano et al. |
| 6,337,836 | June 1999 | Eidelson |
| 5,487,276 | May 1994 | Namisniak |
| 6,752,430 | August 2001 | Holt et al |
| 5,719,828 | October 1990 | Haas et al. |

### BACKGROUND OF THE INVENTION

In many industries, food, pharmaceutical or other areas where the shelf life of materials may be a concern, tracking the time intervals is an important monitoring function. Often, critical dates and times are tracked on a periodic basis over long time intervals. In industries like the pharmaceutical industry, the employees may be charged with monitoring the due dates for recalibration of critical instruments or machinery. This is also true in service providing industries. For example, doctors or dentists often want their patients to make a return visit after a specific interval has passed. The patient is charged with keeping track of the appointment date.

The tracking of critical dates and times is typically accomplished through periodic, manual comparison of the critical date to the current date. This is often assisted by affixing or printing of the critical date in a location that facilitates visual inspection. Food and drug products, for example, have expiration dates printed on their containers that should be examined before use to determine if their expiration dates have passed. In another area, information regarding an appointment is typically provided to a patient in the form of a business card with a handwritten date and time printed on its face. The patient must post this information in a way that will allow him to remember the appointment after months have passed. In the pharmaceutical industry, it is common practice to attach stickers to instruments requiring periodic recalibration. These stickers typically show the date of the last calibration along with the due date of the next calibration. Such instruments may number in the thousands and must be constantly tracked through manual or computerized reminder systems (see U.S. Pat. No. 6,337,836). Owners of automobiles need to track the oil change intervals by frequently checking a sticker typically attached to the windshield.

In recent years, various food labels have been generated. Under regulations from the Food and Drug Administration of the Department of Health and Human Services and the Food Safety and Inspection Service of the U.S. Department of Agriculture, the food label offers more complete, useful and accurate nutrition information than ever before. In general, today's food labels provide consumers with distinctive, easy-to-read formats that enable consumers to quickly retrieve information of major health importance.

Food safety and food quality are of paramount importance. We expect packaged food to be fresh and uncontaminated. Food labels include therefore information about expiration date. However, food products age gradually. Aging does not happen within the day preceding the expiration date. Product quality before the expiration date may not differ noticeably from the product quality during certain time period (see cross-references [1] and [2]). There is no simple timing label for fast, perhaps without reading, indication of a time expiration period of products. Similar problems are encountered by pharmaceutical and other industries.

The dates, for one, mean quite different things. For instance, “sell by” is more a guide for the store to know how long it can display a product for sale. The “best before” or “best if used by” date refers to a quality or flavor of the food. “Use by” works more like an expiration date, similar to that on medicines, and taking them after the date is not recommended.

Some dates can actually be quite misleading. Few consumers, for instance, know when they buy meat, that even if the sell-by date is five days away, the refrigerator at home usually isn't cool enough to keep the meat fresh for more than two days. Usually raw meat is kept around 30 degrees Fahrenheit, while the home refrigerator's temperature is set around 40 degrees to keep other products in the fridge (like vegetables) from freezing. So, food safety experts suggest that whether it's ground meat, or a pound of steak, or chicken, or fish, consumers either eat or freeze it within two days of buying.

The Food & Drug Administration, which regulates packaged foods and drugs, only requires a use-by, or expiration date on infant formula. That is because formula must contain a certain quantity of each nutrient that is described on the label. And if formula is stored too long, it loses its nutritional quality, and also separates or forms lumps that will clog the bottle nipple. The Department of Agriculture, which regulates fresh produce and meats, only requires labeling of the date when poultry is packed at the farm. However, many manufacturers are allowed to also add sell-by or use-by dates. Grocery stores that grind their own meat can add their own package labels.

U.S. Pat. No. 5,487,276 to Johnson describes a food inventory system -a method and device for ensuring the consumption of perishable food items before a safe storage lifetime for the items has elapsed. The electronic warning display for each stored item gives visual warning when the elapsed time approaches and then reaches the safe storage time. U.S. Pat. No. 5,802,015 to Rothschild, et al describes an electronic timing label for indicating the expiration of a time period associated with a particular item. The label comprises a pulse generator and a binary counter. The label also comprises a display for indicating the expiration of the time period.

U.S. Pat. No. 6,397,503 to Cain, et al. describes a food age organization system that incorporates a color-coding system wherein the date upon which a food storage container was placed in a refrigerator can be ascertained quickly and easily. Food and drug safety can be enhanced by using a simple, smart timing, color changing labels. U.S. Pat. No. 4,292,916 to Bradley, et al. describes a disposable timer and product storage condition indicator in which components of a carrier mixture react physically and/or chemically with one or more receptive layers. The carrier mixture and receptive layers are comprised to react during a given time interval, the interval being dependent upon and constantly modified by such external physical conditions as temperature, moisture, light, radiation, or pressure. During the timing period the device can either give a changing color display which is matched in rate to the declining freshness of a food or medicine in a container to which the device is attached or can cause the appearance or disappearance of words or symbols or sticky areas or odors.

U.S. Pat. No. 6,752,430 to Holt, et al. describes a time dependent color-changing security indicator that display visual indicia, e.g., change of color and appearance of a word after a specified or predetermined period of time. A pressure sensitive security sticker is applied to the commercially available plastic ID cards and/or electronically printed documents. The sticker changes color, typically from white to red, after a predetermined period of time. This change in color is caused by the toner/dye/color pigment contained in these documents. U.S. Pat. No. 5,446,705 to Haas, et al. describes a time indicator that changes color or produces an image or information after a specific time interval due to dye migration through an adhesive layer. The discrete adhesive inhibits lateral migration of the dye to preserve the image or information of the dye in a clear and/or understandable condition. U.S. Pat. No. 5,719,828 to Hass et al. describes an indicator that upon activation by a physical contact between an adhesive layer and a substrate cause an ink pattern to gradually bleed and blend together to cause a change visually perceptible through the transparent substrate in a selected time interval.

The electronic timer devices for food and drug storage monitoring are expensive, bulky, inconvenient for applying to food products, and require power supply or batteries, U.S. Pat. No. 6,817,192 to Ector et al. The chemical color changing techniques based on dye or color pigment migration discussed above, see also U.S. Pat. Nos. 5,785,354 and 7,263,037 to Haas, have a number of disadvantages as well that prevents their wide spread use. They are complex multilayer systems, typically require mechanical activation such as by pulling a finger tab, U.S. Pat. No. 5,974,003 to Pedicano et al., have only limited operation time, typically of the order of 24 hours as described in the U.S. Pat. No. 7,294,379 to Ko et al., they are not reusable, are essentially grey scale having small color change range between two colors, U.S. Pat. No. 6,452,873 to Holt et al., such as from white to red, U.S. Pat. No. 6,752,430 to Holt et al, or from opaque to transparent, U.S. Pat. No. 6,801,477 to Braunbergere. Time coding with the aid of labels offered in the prior art may be affected by ambient conditions, U.S. Pat. No. 6,990,688 to Aperfine et al.

Similarly, current technology and procedures for security badges are not flexible to be adapted to meet the needs of increased security with reduced resources. The common form of security labeling for badges is an expiration date which can be difficult to read, requires checkpoints to inspect, cannot be more precise than month/day/year, can appear “valid” after an event (employee dismissal or end of authorized shift or visit). Color changing badges have been developed to address some of these problems. However, they were not widely adopted due to a number of drawbacks: they are functional for very limited time periods (e.g. 4 hours or one day) only; are not reusable; are activated mechanically; provide gradual change of color with low contrast and resolution. Color changing badges may have a number of advantages: increased security; quick visual identification of security status; requires no interpretation of mm/dd/yyyy; limits the required number of checkpoints to manually inspect badges; could be programmed for minutes, hours, days, months or years; allows for the use of more precise time frames than MM/DD/YYYY; allows for use by “shift” employees; allows for use by employees rather than exception based visitors; can be programmed to gradually change colors (green-yellow-red) or jump to expired state (green-red); feasibility to customize the text/information for visitors, guests or employees; can be used indoors or outdoors regardless of environmental or weather conditions.

Thus, the need for simple, inexpensive, high contrast, reusuable, multi-color time coding information carrier such as labels, badges, telephone and gift cards, electronic keys, product labels, shipping tags, storage tags, car oil change stickers, and other carriers of information that by nature is changing as a result of use or storage, and compliance indicators for medical, health, performance enhancement and personal use products have not been met in the prior art.

### BRIEF SUMMARY OF THE INVENTION

The objective of the present invention is providing an optically programmable, multicolor, inexpensive timing label for indicating the expiration of a time period associated with practical applications, uses, and/or consumption of a product.

The second objective of the present invention is providing timing label for displaying visual expiration monitoring color-message.

The third objective of the present invention is providing timing label for product freshness and age information monitoring and giving consumers visual directions on product utility, quality, and safety.

The fifth objective of the present invention is providing timing label for use in dispensing a prescription pharmaceutical to a visually and/or medically impaired user for indicating to the user the pharmaceutical contained therein and the dosage rate.

The next objective of the present invention is providing timing label for use in product identification and stock management.

A further objective of the present invention is providing timing labels for obtaining a color/signal at a selectively predetermined expiration date and time.

Still further objective of the present invention is providing timing labels for metered parking permits, office files, oil change stickers, supervision of prescribed drugs to a patient, and other due date reminders.

The invention includes a liquid crystal photonic bandgap material incorporating photoisomerizable molecular groups such as azobenzene and capable of changing the selective reflection wavelength of the material as a function of photoisomerization ratio. The material encapsulated into a polymer film can be affixed onto or otherwise incorporated into a variety of substrates used for producing labels.

Further objectives and advantages of this invention will be apparent from the following detailed description of presently preferred embodiment, which is illustrated schematically in the accompanying drawings.

### BRIEF DESCRIPTION OF THE SEVERAL VIEWS OF THE DRAWING

FIG. 1(A) schematically shows a photonic bandgap material sandwiched between two substrates and reflecting light of certain color.

FIG. 1(B) schematically shows exposure of a photonic bandgap material containing photoisomerizable dopants to UV light for imposing the desired initial range of the wavelengths of the reflected light color.

FIG. 1(C). schematically shows changed reflected color with passage of time.

FIG. 2(A) schematically shows the pitch of the photonic bandgap and distribution of isomers in the material.

FIG. 2(B) schematically shows changed pitch of the photonic bandgap and changed distribution of isomers causing the change in the pitch.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not limitation.

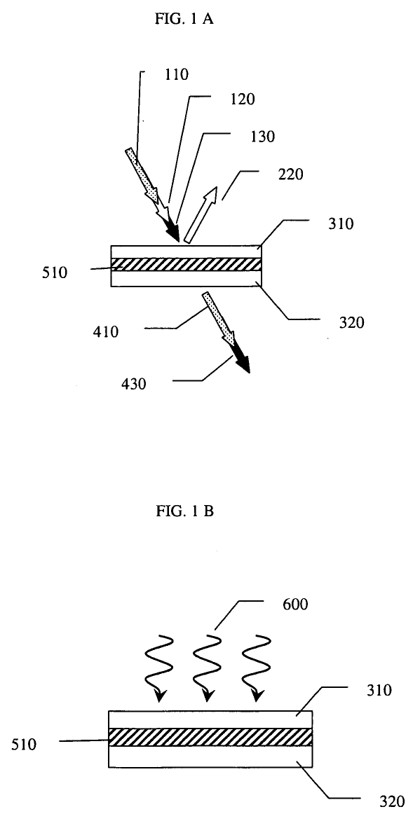

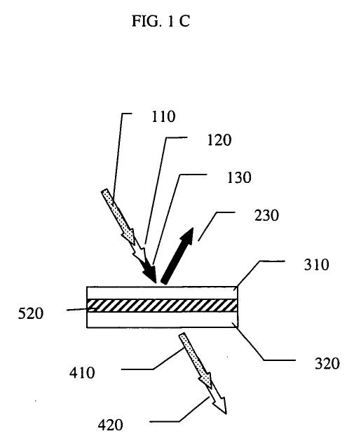

The preferred embodiment of color changing timing label of the present invention shown in FIG. 1(A) comprises a photonic bandgap material 510 such as cholesteric liquid crystal (CLC) sandwiched between transparent substrates 310 and 320 and reflecting one color component 220 out of wide spectrum comprised of light of different colors 110, 120, 130, and transmitting the light components 410 and 430 corresponding to the colors 110 and 130.

FIG. 1(B) illustrates the process of tuning the bandgap to the state of reflected light color corresponding to the start of timing. The material 510 is exposed to UV light 600 with the exposure dose chosen such as to position the reflection band of the photonic bandgap material at the color desired for the start of timing. As shown in the cross-references [3] and [4], the reflected color of CLC bandgaps can be tuned throughout the visible spectrum via UV light exposure. The material with modified spectral position of the bandgap and the reflected light of a changed color are shown in FIG. 1(C) as 520 and 230, respectively.

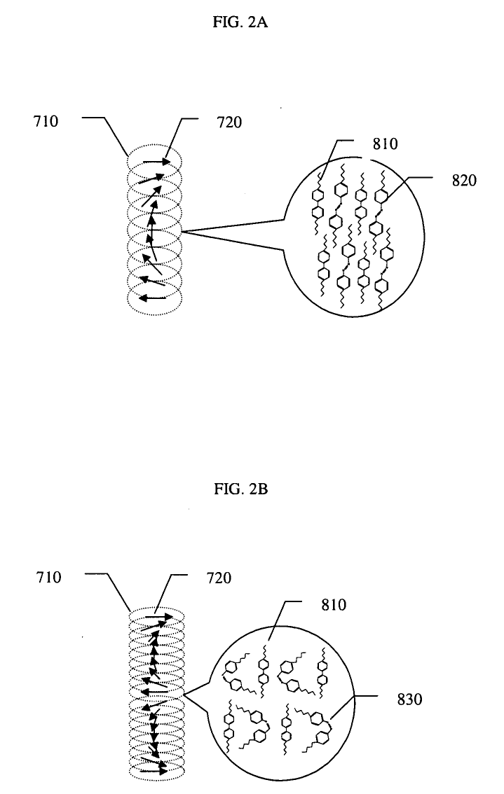

The mechanism behind such color changes is explained in FIGS. 2(A) and (B). The color in photonic bandgap materials is obtained due to periodicity of their structure as opposed to absorption in dyes. Color change is obtained by changing the periodicity of the structure which therefore can cover wide spectral region in a single material. In the preferred embodiment, the photonic bandgap material is a CLC wherein orientation of anisotropic molecules 720 is rotating in space between different material layers 710 in the form of a helix as shown in FIGS. 2(A) and (B). The pitch of the helix that determines its periodicity and therefore the color of the light reflected from the CLC is a result of intermolecular forces. Phototuning properties of the pitch of the CLC helix is imparted upon the molecules 810 making up the CLC material with the aid of photoisomerizable dopant molecules 820 such as molecules containing azobenzene groups. Photoisomerization of said molecules affects the molecular order resulting in the change of the pitch of the helical structure of CLCs.

The lifetime of cis isomers of azobenzene molecules can be chosen to vary from milliseconds to years as discussed in the cross-reference [5]. Hence, the duration of the timing interval can be set by proper choice of azobenzene molecules and their combination. The color coding of the passage of time is also programmed by selecting different dosages of UV light exposure by generating different initial concentration of isomers. The combination of the host CLC and photoisomerizable dopants can be chosen such as exposure to a UV light results in photoinduced phase transition into the isotropic state of the material accompanied by destruction of the photonic bandgap structure and elimination of color related with it as discussed in cross-reference [4]. Restoration of the color from such state takes place as a sharp transition. Thus, the material systems under consideration allow programming not only the duration of the color change, but the rate of the color change as well.

As substrates for the CLC film, one can use, as an example, a sheet or board of polyester based resin such as polyethylene terephthalate, vinyl chloride based resin such as polyvinyl chloride, olefin based resin such as polypropylene, acrylic resin such as polymethyl methacrylate, styrene based resin such as polystyrene, cellulose based resin such as cellulose triacetate, or alternatively a sheet of paper such as coating paper, synthetic paper, metal foil, a ceramic sheet, or a composite sheet produced by combining some of these materials. The thickness of the substrate layer sheet is determined in accordance with uses and typically varies from 50 to 1,000 μm.

The surface of the substrate layer sheet may be treated by any of the well-known adhesion-easing methods, such as the corona treatment, or the primer treatment using a silane coupling agent or urethane resin, in order to improve adhesion between substrate layer sheet and the CLC film.

One of the substrates may preferably contain a protective layer to inhibit the surface deterioration caused by exploitation. Various thermoplastic resins, fluorine resins, silicone resins, thermosetting resins, ultraviolet light curing resins, electron radiation curing resins, etc. can be used as a material for the protective layer. The protective layer may comprise a plurality of layers laminated. The thickness of the protective layer is preferably from 0.1 μm to 20 μm.

Due to the circumstance that the timing is set with the aid of light beams, (1) the label does not enter into physical contact with objects that can damage it or wear it out; (2) there is no need for electroconductive layers or electronics systems, and the label can be reusable.

Although the present invention has been described above by way of a preferred embodiment, this embodiment can be modified at will, within the scope of the appended claims, without departing from the spirit and nature of the subject invention.

What is claimed is:

1. An optically programmable color-changing timing label comprising:
(a) a photonic bandgap material;
(b) a photoisomerizable dopant incorporated into said photonic bandgap material;
(c) substrates embedding said photonic bandgap material and said photoisomerizable dopant incorporated therein;
(d) a light source for photoisomerization.

2. The optically programmable timing label as in claim 1 wherein the photonic bandgap material is a liquid crystal, liquid crystal polymer or a combination of a liquid crystal with a polymer.

3. The optically programmable timing label as in claim 1 wherein the photonic bandgap material consists of periodic distribution of voids infiltrated with a liquid crystal and dopants capable of photoisomerization when exposed to said light source.

4. The optically programmable timing label as in claim 1 wherein the photoisomerizable dopant contains azobenzene, azoxybenzene, or a combination thereof.

5. The optically programmable timing label as in claim 1 wherein the substrates embedding said photonic bandgap material and said photoisomerizable dopant incorporated therein are glass, a flexible polymer, or a combination thereof.

6. The optically programmable timing label as in claim 1 wherein one of the substrates is colored to enhance the contrast.

7. A color changing timing label comprising
(a) a photonic bandgap material;
(b) dopant material;
(c) separate means for holding said dopant material and said photonic bandgap material;
(d) means for triggering diffusion of said dopant material into said photonic bandgap material.

8. The timing label as in claim 7 wherein said means for holding said dopant material and said photonic bandgap material comprise polymer networks.

9. The timing label as in claim 7 wherein said means for triggering the diffusion comprise a porous membrane with its pores opening up and increasing in size upon exposure to light or heat.

10. The label as in claim 1 and claim 7 comprising a cover layer for protecting it from adverse environmental conditions.

11. The label as in claim 1 or claim 7 further comprising a substrate carrying personal or product information.

12. The label as in claim 11 wherein said information carrier is a telephone card, a gift card, electronic key, product label, a security badge, shipping tag, storage tag, car oil change sticker, and other carrier of information that by its nature is changing as a result of use or storage.

13. The label as in claim 11 wherein said substrate carrying information is paper, plastic, fabric, glass, metal foil, or another thin and flexible material.
